(19) United States
(12) Patent Application Publication
(10) Pub. No.: US 2008/0067882 A1
(43) Pub. Date: Mar. 20, 2008

(54) MOTOR

(75) Inventor: Satoshi Murata, Nishikamo-gun (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/854,766

(22) Filed: Sep. 13, 2007

(30) Foreign Application Priority Data
Sep. 15, 2006 (JP) 2006-251708

(51) Int. Cl. H02K 9/19

(52) U.S. Cl. 310/54

(57) ABSTRACT

A motor that includes a stator and an oil passage that supplies oil to the stator is provided with a heat absorbing portion of a heat pipe in a position inside the oil passage and contacting or near the stator.

### INCORPORATION BY REFERENCE

The disclosure of Japanese Patent Application No. 2006-251708 filed on Sep. 15, 2006, including the specification, drawings and abstract is incorporated herein by reference in its entirety.

### BACKGROUND OF THE INVENTION

1. Field of the Invention

The invention relates to a motor. More particularly, the invention relates to a motor in which the stator can be efficiently cooled.

2. Description of the Related Art

Japanese Patent Application Publication No. 2005-73364 (JP-A-2005-73364), for example, describes a related in-wheel motor in which the cooling efficiency has been improved by reducing heat resistance between a housing and a stator by supplying oil from around a stator core and filling up a space between the housing and the stator core with oil, and having the oil from an oil pump pass through an oil cooler which consists of a plurality of fins.

Also, Japanese Patent Application Publication No. 4-185263 (JP-A-4-185263), for example, describes a related wheel motor in which the stator is cooled by being supplied with oil which has been cooled by cooling fins and heat pipes. The oil is drawn up by an oil pump motor in a bottom portion from an oil reservoir and supplied to an oil passage outside the case. It is this oil passage that is provided with the cooling fins and heat pipes. This oil passage is communicated with an oil passage provided in the upper portion inside the case. Accordingly, oil which has been cooled by the cooling fins and heat pipes is supplied to the stator from an outlet of the inside oil passage.

However, with the structure described in JP-A-2005-73364 described above, the oil delivered by the oil pump is cooled by the oil cooler so the stator core, which is the object to be cooled, is unable to be cooled directly. Also, the oil cooler used is simply a plurality of fins.

Also, with the structure described in JP-A-4-185263, both heat pipes, which has high cooling efficiency, and cooling fins are used. However, the oil is cooled close to the oil pump motor, which is far from the stator that is the object to be cooled. Therefore, similar to the case of JP-A-2005-73364, the stator is unable to be cooled directly.

### SUMMARY OF THE INVENTION

This invention thus provides a motor with improved stator cooling efficiency by cooling the stator, which is the object to be cooled, directly.

A first aspect of the invention relates to a motor that includes a stator and an oil passage that supplies oil to the stator, in which a heat absorbing portion of a heat pipe is provided in a position inside the oil passage and contacting or near the stator. Accordingly, the stator can be more directly cooled using the heat pipe which has high cooling efficiency. As a result, the cooling efficiency can be improved.

Further, in the motor according to this aspect, the heat pipe may have a heat radiation portion provided outside of the oil passage. Accordingly, the heat radiation portion can be cooled outside the oil passage so that heat removed by the heat absorbing portion can be efficiently dissipated.

Moreover, in the motor according to foregoing aspect, the motor may be housed in a motor case, and the heat absorbing portion of the heat pipe may be provided inside the oil passage arranged between an outer periphery of the motor and the motor case. Accordingly, the stator can be directly cooled in a motor provided with a motor case.

Also, in the motor according to the foregoing aspect, the heat radiation portion of the heat pipe may be provided on an outer portion of the motor case and formed integral with a radiation fin. Accordingly, the heat from the stator that was removed by the heat absorbing portion of the heat pipe can be efficiently dissipated.

Also, in the motor according to the foregoing aspect, the heat radiation portion of the heat pipe may be provided inside a radiation rib provided on an outer periphery of the motor case. Accordingly, the heat pipe can be arranged in a high position, thereby reducing the risk of damage to the heat pipe by flying rocks or the like.

According to the invention, the stator of the motor, which is a heat generating body, can be directly cooled, thereby improving cooling efficiency.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a sectional view of the structure of a motor according to one example embodiment of the invention;

FIG. 2 is a view illustrating oil passages for cooling a stator and lubricating bearings, heat pipes, and radiation fins;

FIG. 3 is a sectional view illustrating the stator being cooled by only oil circulation;

FIGS. 4A and 4B are sectional views of a motor according to a modified example which differs from the example embodiment shown in FIGS. 1 and 2, with FIG. 4A being a sectional view of the motor according to this modified example, and FIG. 4B showing the motor taken along line X-X in FIG. 4A;

FIG. 5 is a front view showing the positional relationship of the heat pipes, oil passages, and an oil delivery, as well as other constituent elements of the motor according to this modified example;

FIG. 6 is a sectional view showing the main structure of an in-wheel motor assembly to which the motor according to the example embodiment of the invention has been applied;

FIG. 7 is a view of oil passages for cooling a motor and lubricating bearings, and heat pipes provided in the cooling oil passages;

FIG. 8 is a sectional view which is cut along a different plane than the sectional view shown in FIG. 6 and shows the relationship between the heat pipes and the flow of oil near the upper portion of the motor; and

FIG. 9 is a sectional view showing the main structure of an in-wheel motor assembly to which the motor according to the modified example of the example embodiment of the invention has been applied.

### DETAILED DESCRIPTION OF THE EMBODIMENTS

In the following description and the accompanying drawings, the present invention will be described in more detail in terms of example embodiments.

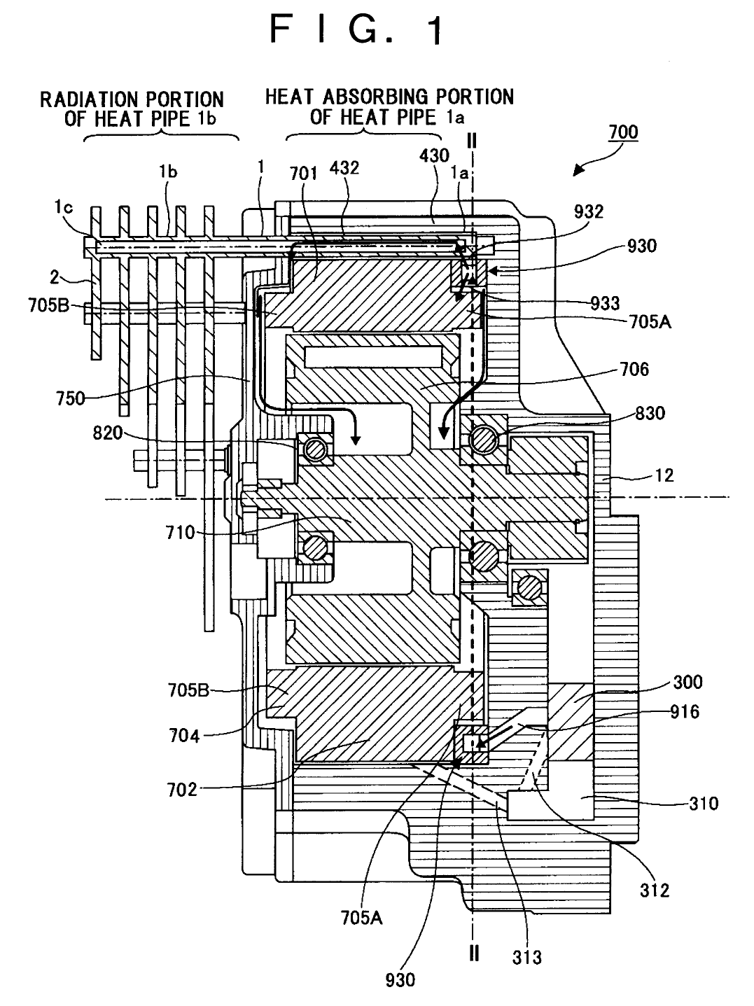

FIG. 1 is a sectional view of the structure of a motor according to one example embodiment of the invention. The main constituent elements of the motor 700 according to this example embodiment are a stator 701, a rotor 706, a motor case 12, a case cover 750, an oil tank 310, an oil pump 300, a pressure oil passage 916, an oil delivery 930, an oil passage 432, heat pipes, and radiation fins 2.

The stator 701 includes a stator core 702 and a stator coil 704. The stator core 702 may be made of thin iron sheets stacked together in a direction perpendicular to the radial direction or made of an integrated iron core, though the stacked structure may be easier to manufacture. If the motor 700 is a three-phase motor, the stator coil 704 may consist of a U-phase coil, a V-phase coil, and a W-phase coil. The motor according to this example embodiment is a brushless motor in which coils are wound around the stator 701. Because the stator 701 generates heat by the coils wound around it, there is a great need to improve cooling efficiency.

The rotor 706 is arranged facing the stator 701 in the radial direction. The rotor 706 may be any material as long as it generates a magnetic pole corresponding to the magnetic pole of the stator 701. For example, the rotor 706 may be a permanent magnet.

Also, the rotor 706 is provided with an output shaft 710 which may be provided with a gear or the like that can transmit or receive driving force. This output shaft 710 is rotatably supported by the case cover 750 via a bearing 820, while being rotatably supported by the motor case 12 via a bearing 830 on the opposite side. Incidentally, the bearings 820 and 830 may be radial ball bearings which use balls as rolling bodies, such as single-row, deep-grooved ball bearings, for example.

The motor case 12 may house the stator 701, the rotor 706, and other constituent elements in order to protect the motor 700.

Similarly, the motor cover 750 may house the stator 701, the rotor 706, and other constituent elements of the motor in combination with the motor case 12. The motor cover 750 may be separate from the motor case 12 in order to make it easier to house the motor 700 during assembly.

The oil tank 310 stores oil and is provided in a bottom portion inside the motor case 12. The oil is used to cool the stator 701 and lubricate the bearings and the like. The oil tank 310 is positioned such that oil can be drawn up by an oil pump 300 and therefore also serves as an oil supply tank from which oil can be supplied to the motor 700. Also, the oil tank 310 is positioned below the rotor 706 and is communicated with an oil return path 313 which is provided below the rotor 706 inside the motor case 12. Therefore, the oil tank 310 also serves as an oil reservoir that receives oil that has been circulated.

The oil pump 300 draws up oil from the oil tank 310 via a suction path 312 and supplies it to the pressure oil passage 916. The oil is then supplied from this pressure oil passage 916 to the oil delivery 930.

The oil delivery 930 is an arc-shaped oil passage provided in the space between the stator core 702 and the motor case 12. Oil is circulated from vertically below than the stator 701 to above the stator 701 along the outer periphery of the stator core 702, and then back to below the stator on the opposite side, thereby encircling the stator core 702.

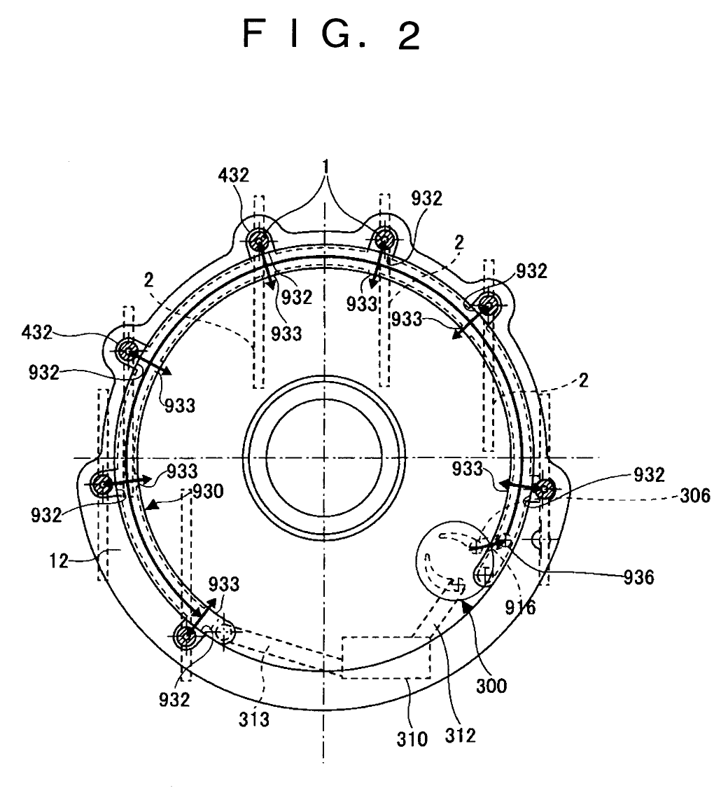

FIG. 2 is a view showing the heat pipes 1, the radiation fins 2, and the oil passages for cooling the stator 701 and lubricating the bearings 820 and 830. The drawing is a front view of the inside of the motor case 12 with the motor cover 750 and the internal elements of the motor 700 omitted, and is centered around a vertical section (section II-II) that includes the oil delivery 930 in FIG. 1. In FIG. 2, members of little relevance in describing the oil passages are omitted as appropriate.

In FIG. 2, the oil pump 300 draws up oil from the oil tank 310 via the suction path 312 and supplies it to the oil delivery 930 through the pressure oil passage 916. The oil then rises inside the oil delivery 930, which is an arc-shaped oil passage, until it reaches the highest point, after which it flows down inside the oil delivery 930 along the arc shape of the circular oil passage and ultimately returns to the oil tank 310 from the oil return path 313 provided in the motor case 12 under the rotor 706. While the oil is circulating, oil is distributed among two kinds of holes provided in a plurality of locations, i.e., distribution holes 933 for distributing oil to the inside the stator 701, and distribution holes 932 for distributing oil to the outside of the stator 701.

Returning to FIG. 1, the path along which the oil circulates will now be described. As described with reference to FIG. 2, the oil that was supplied to the lower portion of the oil delivery 930 circulates along the outer periphery of the stator core 702 until it reaches the upper portion of the oil delivery 930. The oil is then supplied to the oil passages 432 through the distribution holes 932 which open to the outside in the radial direction and are connected to the oil passages 432, as shown by the dotted line in the drawing. Similarly, oil is supplied from a coil end 705A of the stator core 702 through the distribution holes 933 that are open to the inside in the radial direction and are connected to the inner peripheral side of the stator core 702.

The oil passages 432 are formed in positions contacting the stator, and extend in a direction parallel with the output shaft 710 along the outer periphery of the stator 701. Oil flows through the oil passages 432 from the coil end 705A side toward the coil end 705B side. At this stage, oil is supplied to the stator 701 from above, thus cooling the stator 701. Also, oil that has reached the coil end 705B flows down between the case cover 750 and the stator 701, where it is supplied to the bearing 820.

Meanwhile, oil that is supplied to the inner peripheral side of the stator on the coil end 705A side cools the coil end 705A side and flows down between the motor case 12 and the stator 701, where it passes through the rotor 706 and lubricates the bearing 830.

Here, heat absorbing portions 1a of the heat pipes 1 are provided inside the oil passages 432. These heat absorbing portions 1a absorb heat generated by the stator 701. The thermal conductivity of the heat pipes 1 is much greater than the thermal conductivity of the oil so providing these heat pipes 1 which have high thermal conductivity in a position contacting or near the stator 701 in the oil passages 432 enables the heat generated by the stator 701, which is a heat generating body, to be more efficiently absorbed.

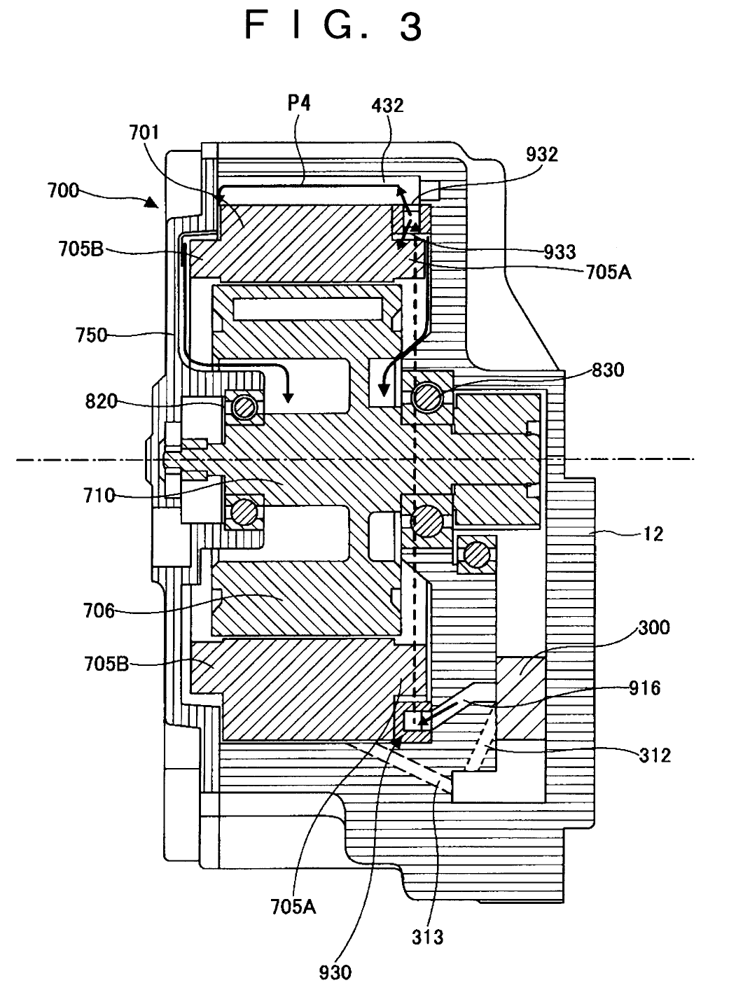

This point will now be described comparing FIG. 1 with FIG. 3.

For example, FIG. 3 is a sectional view that illustrates cooling by only oil circulation, i.e., the heat pipes 1 from FIG. 1 has been omitted. Oil passes from the oil delivery 930 at the upper portion of the stator 701 through the distribution holes 932 and then through the oil passages 432, as shown by arrow P4, from which it is supplied to the upper portion of the stator 701 to cool the stator 701. The oil inside the oil passages 432 removes heat from the stator 701 with which it is in contact, and carries heat away that was removed from the coil end 705B, such that some degree of cooling effect can be obtained. However, the heat that is removed from the stator 701 in the oil passages 432 is limited by the thermal conductivity of the oil.

Returning now to FIG. 1, in the structure shown in FIG. 1, the heat absorbing portions 1a of the heat pipes 1 are provided inside the oil passages 432 and enable the heat generated by the stator 701 to be directly and efficiently absorbed by providing the heat pipes 1 in positions contacting or near the stator 701 inside the oil passages 432. Accordingly, the heat absorption efficiency is higher and heat generated by the stator 701 is able to be carried away more efficiently than it is when only the oil passages 432 are provided, as in the structure shown in FIG. 3.

In order to efficiently remove heat generated by the stator 701, which is a heat generating source, the heat absorbing portions 1a of the heat pipes 1 may also be provided contacting the stator 701. Providing the heat absorbing portions 1a in contact with the stator 701 enables the heat from the stator 701 to be directly absorbed. However, due to machining tolerances and difficulties in manufacturing, it is not always possible to provide the heat absorbing portions 1a of the heat pipes 1 in contact with the stator 701. Even in these cases, the heat absorbing portions 1a may be arranged in positions as close to the stator 701 as possible so that the heat from the stator 701 can be directly absorbed. In this case, heat generated by the stator 701 is absorbed through the oil between the stator 701 and the heat absorbing portions 1a of the heat pipes 1.

The heat pipes 1 may also be provided with heat radiation portion 1b on an outer portion of the oil passages 432 because of the need to radiate the heat from the stator 701 that was removed inside the oil passages 432 to the outside. Furthermore, the heat radiation portion 1b of the heat pipes 1 may also be provided outside of the motor case 12 or the case cover 750. Providing the heat radiation portion 1b of the heat pipes 1 on the outer portion of the motor 700 enables heat generated inside the motor 700 to be carried away to outside the motor 700.

The heat radiation portion 1b of the heat pipes 1 may be provided integrally with the radiation fins 2 because the radiation function of the radiation fins 2 enables the heat from the heat radiation portion 1b to be released even more efficiently to the outer portion. Each heat radiation portion 1b may also be provided with a plurality of the radiation fins 2 to increase the overall surface area of the fins and effectively radiate heat. Also, the radiation fins 2 may be any one of a variety of shapes. For example, a plurality of flat plates may be stacked at predetermined intervals in the length direction of the heat pipes 1, or a plurality of rod-shaped radiation fins 2 may be provided at predetermined intervals.

The heat pipes 1 are metal pipes each having a capillary tube structure inside a pipe. The inside may be a vacuum with a small amount of operating liquid 1c such as water or a chlorofluorocarbon substitute sealed inside. Incidentally, the metal used may be one with excellent thermal conductivity such as copper or aluminum.

The operation of the heat pipes 1 may be as follows, for example. That is, when the stator 701 generates heat, that heat is absorbed by the heat absorbing portions 1a, causing the operating liquid 1c inside to evaporate and the evaporative latent heat to be absorbed. The evaporation gas then moves at a high velocity, i.e., around the velocity of sound, to the heat radiation portion 1b where it is cooled and thus condenses, returning to its liquid state, thereby releasing the evaporative latent heat. The condensed operating liquid 1c then returns to the heat absorbing portions 1a through the capillary tube structures, thereby enabling heat to be continuously and efficiently moved.

Incidentally, the heat pipes 1 may be embedded by press-fitting into the stator core 702 of the stator 701 so that they remove the heat from the stator 701 more directly. However, because the stator core 702 is constructed of thin plates stacked together, as described above, tiny spaces which do not conduct heat well tend to form between the thin plates. Also, even if the stator 701 is initially formed of a single piece of iron, it is extremely difficult to press fit the heat pipes 1 into the stator core 702 due to machining tolerances and other difficulties in manufacturing.

Therefore, by arranging the heat absorbing portions 1a of the heat pipes 1 in positions contacting or close to the stator 701 in the oil passages 432 as described in this example embodiment, contact with the stator 701 can be reliably ensured either directly or through oil so that the heat transmitted from the stator 701 either directly or through the oil can be quickly carried to the heat radiation portion 1b and released. As a result, the heat generated by the stator 701 can be effectively dissipated. That is, contact with the heat source can be reliably ensured using oil as a heat exchange medium, and the transmitted heat can be quickly moved and released outside the stator 701. As a result, the stator 701 can be efficiently cooled without involving machining difficulties.

Also, when the motor 700 according to this example embodiment is used in a vehicle or a car of a train and is arranged in a position near the ground, the heat radiation portion 1b of the heat pipes 1 which are provided outside the motor case 12 may become damaged by flying rocks or the like. Even in this case, only the heat pipes 1 would be damaged. The oil passages 432 would be unaffected so oil for cooling and lubricating would not leak outside. For example, even if the heat radiation portion 1b of the heat pipes 1 were to become damaged by flying rocks or the like, operating liquid 1c may leak from that location resulting in a drop in the cooling performance, but the damage would only be to the outside of the oil passages 432 and would not effect the oil passages 432 themselves. Therefore, even if a portion of the heat pipes 1 was damaged, impaired motor function due to overheating or internal bearing or gear damage due to a lack of lubrication, which can otherwise occur if the oil passages are damaged, would not occur. This is in contrast to the effect on the engine if oil were to leak from the radiator of the vehicle.

Next, the positional relationship, as viewed from the front, of the heat pipes 1, the oil passages 432, and the other constituent elements of the motor according to this example embodiment will be described with reference to the front view in FIG. 2.

As described above, the oil delivery 930 is arranged in an arc shape generally along the outer periphery of the stator 701, with the oil passages 432 provided on the outer peripheral side of the oil delivery 930 at seven locations at appropriate intervals. The heat pipes 1 are provided in the oil passages 432 extending perpendicular to the paper on which FIG. 2 is drawn. Oil is supplied to the oil passages 432 from the oil delivery 930 through the distribution holes 932 that open to the outside in the radial direction. Similarly, oil is supplied to the stator 701 through the distribution holes 933 that open to the inside in the radial direction.

Heat from the stator 701 is absorbed by the heat absorbing portions 1a, not shown, of the heat pipes 1 on the outside of the stator 701 inside the oil passages 432. When the heat pipes 1 are provided contacting the stator 701, the heat absorbing portions 1a of the heat pipes 1 directly absorb the heat. When the heat pipes 1 are provided close to the stator 1, the heat absorbing portions 1a of the heat pipes 1 absorb the heat from the stator 701 via the oil in the space between the heat pipes 1 and the stator 701.

The heat that was absorbed by the heat absorbing portions 1a of the heat pipes 1 moves at a high rate of speed from the front side of the paper on which FIG. 2 is drawn toward the back side of the paper and is dissipated by the radiation fins 2 provided on the heat radiation portions 1b. The radiation fins 2 may be long thin fins extending vertically, as shown by the broken lines, on the oil passages 432 formed in the upper portion of FIG. 2, for example. The radiation fins 2 are not limited to this shape, however, i.e., radiation fins 2 of various shapes that efficiently radiate heat may be used.

Also, the example shown in FIG. 2 shows seven heat pipes 1 provided along the outer periphery of the stator 701 but more or less may be provided.

Further, the example shown in FIG. 2 shows oil supplied by the arc-shaped oil delivery 930 along the coil end 705A of the stator 701. However, an oil supply passage may also be provided that carries oil from the oil tank 310 directly to the upper portion of the stator 701. By providing the heat pipes 1 in positions that contact or are close to the stator 701 in the oil passages 432 that supply oil to the stator 701, the heat pipes 1 can be set as desired regardless of the oil supply route and the like.

In this way, according to the motor 700 having the structure described with reference to FIGS. 1 and 2, by using oil, which has good permeability, as the heat exchange medium and arranging the heat pipes 1, which conduct heat extremely well, near the stator 701 which is a heat generating source, the heat generated by the stator 701 can be rapidly carried away to the outer portion the motor case 12. Then, the heat that is carried away to the outer portion of the motor case 12 can be effectively dissipated using the radiation fins 2 which have a large surface area and radiate heat extremely well. Thus this structure and operation enable the stator 701 to efficiently cooled.

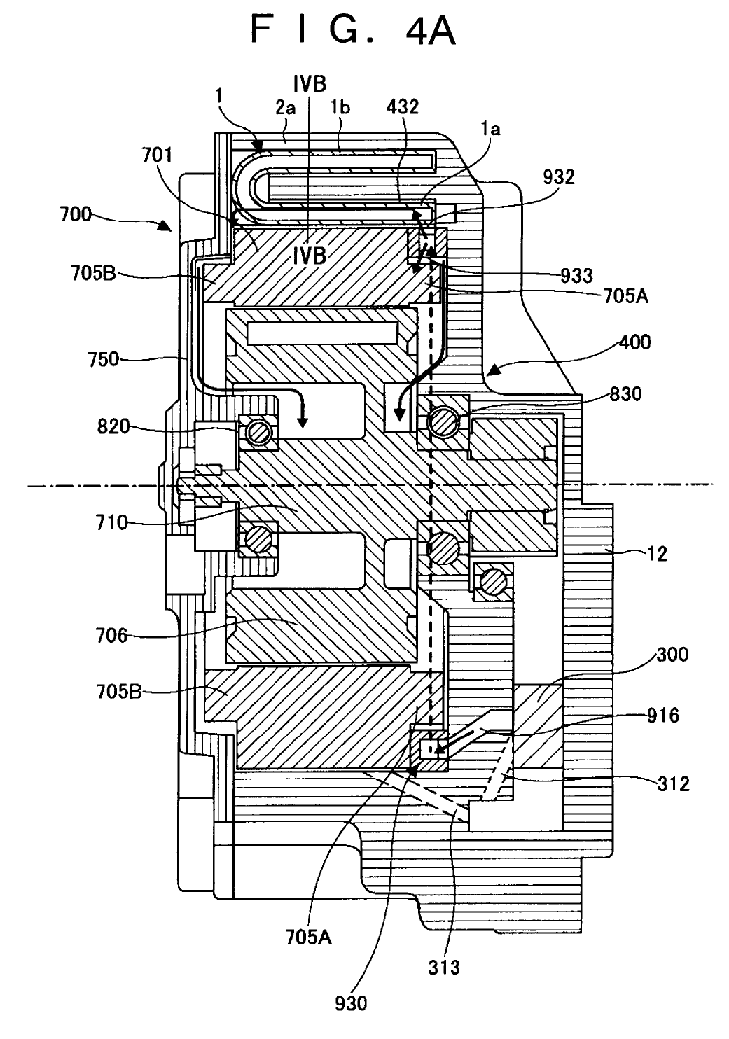

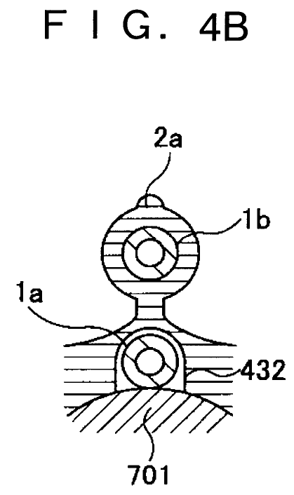

FIGS. 4A and 4B are sectional views of the motor 700 according to a modified example of the foregoing example embodiment of the invention. FIG. 4A is a sectional view of the motor 700 according to this modified example, and FIG. 4B is a sectional view taken along line X-X in FIG. 4A.

In FIGS. 4A and 4B, the shape of the heat pipes 1, and thus the shape of the motor case 12, is different from that shown in FIGS. 1 and 2. However, the other constituent elements are generally the same so the lower one-fifth or so of the motor 700 is omitted. Also, the constituent elements that are the same as those shown in FIGS. 1 and 2 will be denoted by the same references numerals and descriptions of those elements will be omitted.

In FIG. 4A, the heat absorbing portions 1a of the heat pipes 1 are provided in positions contacting or close to the outer periphery of the stator 701 inside the oil passages 432, just as in the example embodiment shown in FIG. 1. However, in this modified example, the heat pipes 1 are bent in the middle such that the heat radiation portion 1b are inserted into holes in radiation ribs 2a provided on the outer periphery of the motor case 12, which differs from the foregoing example embodiment described above.

The radiation ribs 2a are integrally provided continuous with the motor case 12 on the outer peripheral side of the motor case 12. Integrally providing the radiation ribs 2a in this manner enables the heat pipe heat radiation portion 1b to be stably supported and also enables the entire motor 700 to be more compact. Because the radiation ribs 2a are provided so as to support the heat radiation portion 1b of the heat pipes 1 inside them on the outer peripheral portion of the motor case 12, this structure protects the heat radiation portion 1b of the heat pipes 1 better than the foregoing example embodiment shown in FIG. 1, reducing the possibility of damage to the heat pipes 1 by flying rocks or the like.

The oil inside the oil passages 432 is supplied from the oil delivery 930 through the distribution holes 932 in the outside in the radial direction, flows along in the direction in which the oil passages 432 extend, and down toward the coil end 705B. However, the oil passages 432 on the side near the coil end 705B are structured such that the heat radiation portion 1b of the heat pipes 1 are completely enclosed in the holes in the outside ribs 2a so that oil will not flow into the heat radiation portion 1b side.

Regarding this point, the heat absorbing portions 1a of the heat pipes 1 are provided inside the oil passages 432, as shown in FIG. 4B, but there is a space through which oil is able to flow between the area around each of the heat absorbing portions 1a of the heat pipes 1 and the oil passages 432. Meanwhile, the radiation ribs 2a are provided protruding from the outer peripheral portion of the motor case 12 in which the oil passages 432 are housed. The radiation ribs 2a house, in a sealed manner, and support the heat radiation portion 1b of the heat pipes 1 in holes therein. A protrusion on the top of the radiation ribs 2a efficiently radiate the heat from these heat radiation portions 1b.

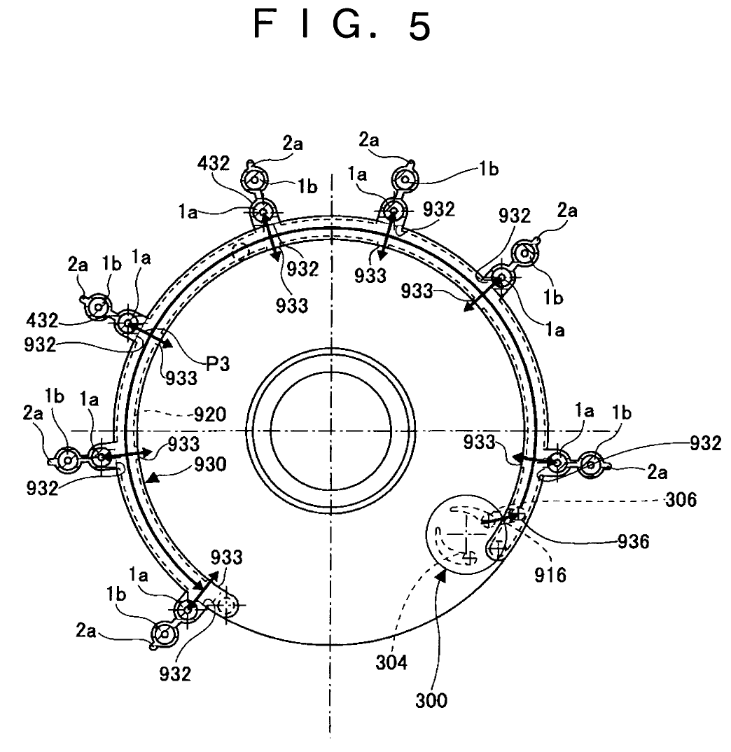

FIG. 5 is a front view of the positional relationship of the heat pipes 1, the oil passages 432, the oil delivery 930, and the other constituent elements of the motor 700 according to this modified example, and corresponds to FIG. 2. The other constituent elements of this modified example are generally the same as those shown in FIG. 2. Also, the only difference lies in the shape of the heat pipes 1 and the radiation ribs 2a which replace the radiation fins 2.

In FIG. 5, the heat absorbing portions 1a of the heat pipes 1 are provided inside the oil passages 432 and the radiation ribs 2a are provided on the outer peripheral side of the motor corresponding to the oil passages. Having the heat radiation portion 1b of the heat pipes 1 inside of the radiation ribs 2a in this way enables the stator 701 to be cooled substantially uniformly from the outer periphery. Also, the cooling effect can be further increased by increasing the number of oil passages 432 and heat pipes 1.

In this way, with the motor 700 according to the modified example described with reference to FIGS. 4 and 5, not only is the possibility of damage to the heat pipe 1 from flying rocks and the like reduced, but also the entire motor 700 is able to be made compact and the cooling efficiency of the stator 701 is able to be increased.

The motor 700 according to the modified example described above, is not particularly limited in terms of use. For example, it may be used in a train or a vehicle or the like. In particular, when the motor 700 is used in a vehicle, it can be applied to various types of vehicles such as hybrid vehicles, electric vehicles, and vehicles provided with in-wheel motors. Therefore, an example in which the motor 700 of the invention is applied to an in-wheel motor will be described.

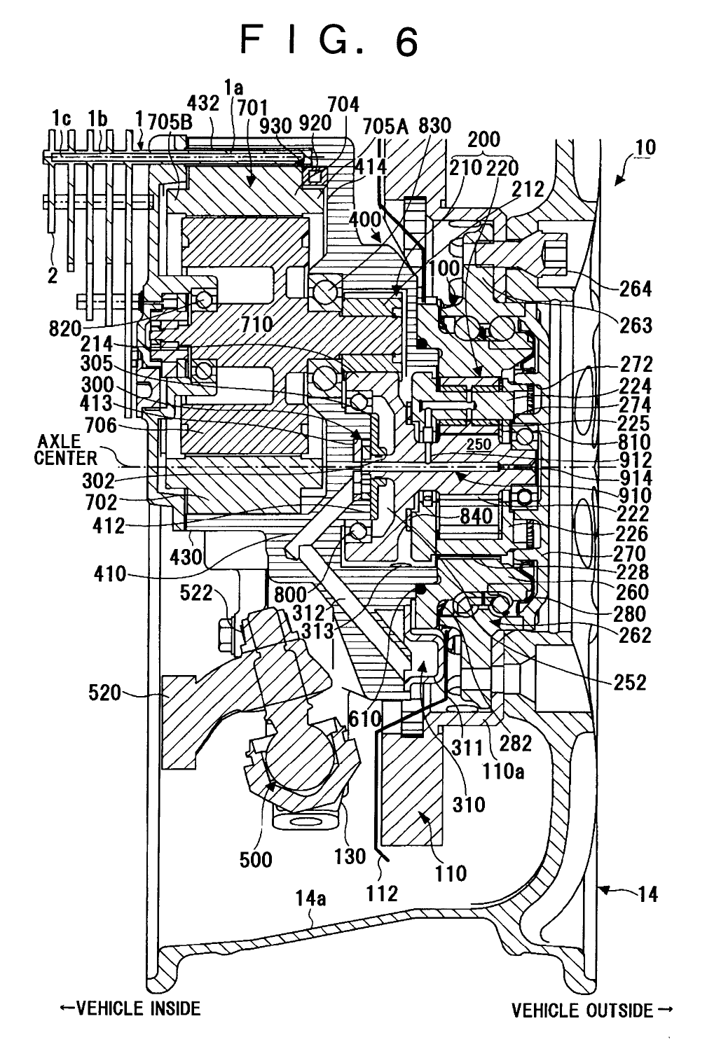

FIG. 6 is a sectional view of the main structure of a wheel assembly with an in-wheel motor to which the motor according to the foregoing example embodiment of the invention is applied. In the drawing, the tire, as well as the upper ⅓ or so of the wheel, is omitted.

A tire/wheel assembly 10 includes a wheel 14 to which a tire, not shown, is mounted. As will be described in detail later, the main portions of constituent elements relating to the motor are housed inside a space that is enclosed by a rim inner peripheral surface 14a of the wheel. In the following description, the words “inside of the tire/wheel assembly” refer to the generally columnar space that is enclosed by the rim inner peripheral surface 14a of the wheel 14. However, expressions such as “a part is arranged inside the tire/wheel assembly” do not always mean that the entire part is housed completely within this generally columnar space. They also include structures in which a portion of the part partially protrudes from within that generally columnar space.

Arranged within a tire/wheel assembly 10 are mainly an axle bearing 100, a brake disc 110, a brake dust cover 112 that covers the brake disc 110 from the inner side of the vehicle in the vehicle width direction (hereinafter also referred to simply as “vehicle inside”), a brake caliper (not shown), the motor 700 for driving the wheel, a reduction mechanism 200, the oil pump 300, an oil tank (i.e., the oil reservoir) 310, oil passages 910 and 920, a knuckle (i.e., a carrier) 400, and a lower ball joint 500 that is connected to a wheel-side end portion of a lower arm 520. Also, a ball joint, not shown, that is connected to a wheel-side end portion of a tie-rod, not shown, and an upper ball joint, not shown, that is connected to the wheel-side end portion of an upper arm, not shown, are also arranged in the tire/wheel assembly 10. However, when strut type suspension is used, the lower end of the strut (i.e., shock absorber), instead of the upper arm, is connected to the upper side of the knuckle 400.

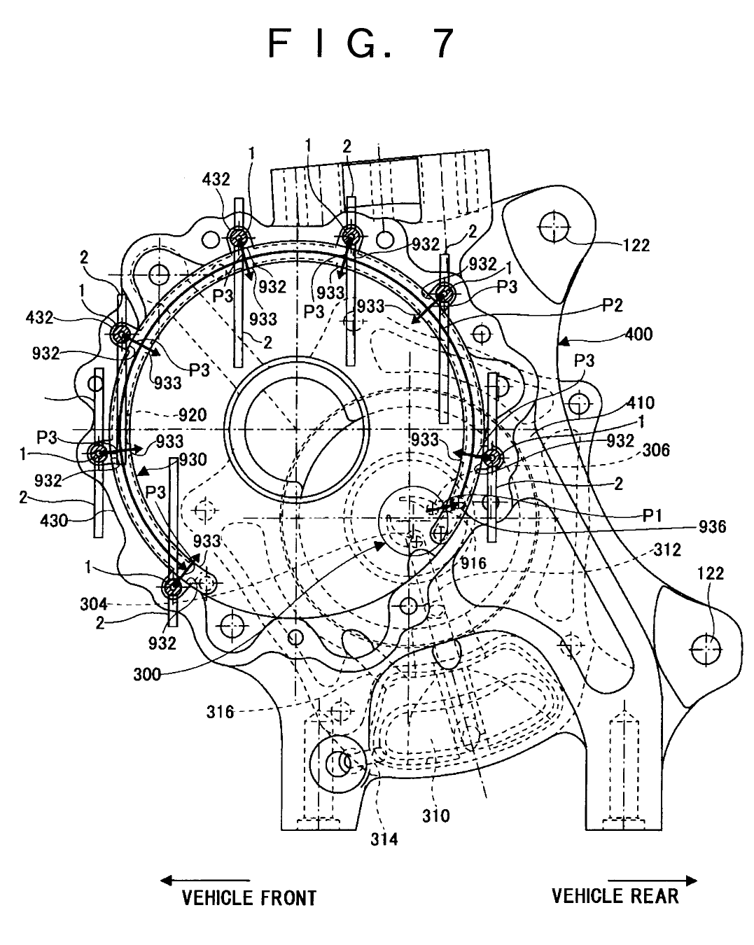

The motor 700 is arranged in a space on the vehicle inside within the tire/wheel assembly 10. As shown in FIG. 6, the motor 700 is arranged offset upward and forward with respect to the axle center (see FIG. 7). Accordingly, a space not occupied by the motor 700, which corresponds to the amount that the motor 700 is offset, is created to the lower rear on the vehicle inside within the tire/wheel assembly 10, as shown in FIG. 6. Therefore, the lower space on the vehicle inside within the tire/wheel assembly 10 is larger than it is with a structure in which the motor is arranged on the same axis as the axle center. As a result, there is a larger degree of freedom for arranging the suspension on the lower side.

The motor 700 includes the stator 701 and the rotor 706. The stator 701 includes the stator core 702 and the stator coil 704. If the motor 700 is a three phase motor, the stator coil 704 may include a U phase coil, a V phase coil, and a W phase coil. The rotor 706 is arranged on the inner peripheral sides of the stator core 702 and the stator coil 704.

The rotor 706 of the motor 700 has the output shaft 710, the rotational center of which is offset with respect to the axle center, as described above. The output shaft 710 is rotatably supported by the motor cover 750 via the bearing 820 on the vehicle inside in the tire/wheel assembly 10, as well as rotatably supported by the knuckle 400 (main structure portion 410) via the bearing 830 on the outer side of the vehicle in the vehicle width direction (hereinafter also referred to simply as “vehicle outside”) in the tire/wheel assembly 10. The bearings 820 and 830 may be radial ball bearings which use balls as rolling bodies, such as single-row, deep-grooved ball bearings, for example.

The rotational output of the motor 700 is transmitted to the wheel 14 via the reduction mechanism 200. The reduction mechanism 200 is a twin shaft reduction mechanism which includes a counter gear mechanism 210 and a planetary gear set 220. Thus the reduction mechanism 200 realizes a two step reduction. Gears 212, 214, 222, 224, 226, and 228 of the reduction mechanism 200, which will be described below, may be helical gears.

As shown in FIG. 6, the counter gear mechanism 210 is arranged farther to the vehicle outside than the motor 700. The counter gear mechanism 210 includes a small diameter driving gear 212 which is arranged on the output shaft 710 of the motor 700, and a large diameter driven gear (i.e., a counter gear) 214 that is in mesh with the driving gear 212. The small diameter driving gear 212 is spline fitted to the output shaft 710 of the motor 700 from the vehicle outside, and thus integrated with the output shaft 710. The large diameter counter gear 214 is formed with the axle center as its rotational center. Thus, the output shaft 710 of the motor 700 is arranged offset with respect to the axle center by approximately the distance of the combined radii of the driving gear 212 and the counter gear 214.

As shown in FIG. 6, the planetary gear set 220 is arranged farther to the vehicle outside than the counter gear mechanism 210 within the tire/wheel assembly 10. The planetary gear set 220 is arranged on the same axis as the axle center, and includes a sun gear 222, a planetary gear 224, a planetary carrier 226, and a ring gear 228.

The sun gear 222 is connected to the counter gear 214 of the counter gear mechanism 210. In the example shown in FIG. 6, the sun gear 222 is formed on one end side of a shaft (i.e., sun gear shaft) 250 and the counter gear 214 is formed on the other end side of the shaft 250 in the width direction of the vehicle. More specifically, the shaft 250 has a rotational center that is on the same axis as the axle center. The sun gear 222 is positioned on the peripheral surface of the end portion on the vehicle outside, and the counter gear 214 is positioned on the peripheral surface of the end portion on the vehicle inside. The end portion of the shaft 250 on the vehicle inside is rotatably supported by the knuckle 400 via a bearing 800, and the end portion of the shaft 250 on the vehicle outside is rotatably supported by a disc-shaped power transmitting member 270 via a bearing 810. The sun gear 222 and the counter gear 214 may also be formed as separate parts, in which case they may be connected using splines. Also, the bearings 800 and 810 may be radial ball bearings which use balls as rolling bodies, such as single-row, deep-grooved ball bearings, for example. Further, as shown in FIG. 6, the bearing 800 may be incorporated inside (i.e., on the inner peripheral side of) the counter gear 214, and a convex portion 412 of the knuckle 400 connected by press-fitting or the like to the inner race side of the bearing 800.

The planetary gear 224 is in mesh with the sun gear 222 on the inner peripheral side and in mesh with the ring gear 228 on the outer peripheral side. The planetary gear 224 is rotatably supported around a roller shaft 225 via a roller bearing by the planetary carrier 226. The rotational center of the planetary carrier 226 is the same as the axle center. The planetary carrier 226 is supported at the vehicle inside within the tire/wheel assembly 10 by the shaft 250 via a thrust cylindrical roller bearing 840, and is spline fitted at the vehicle outside to a circumferential groove 272 formed circumferentially in the power transmitting member 270. A plurality of the planetary gears 224 are arranged at equidistant intervals around the sun gear 222. The planetary gears 224 and the planetary carrier 226 are assembled to form a single unit (hereinafter referred to as “planetary gear unit”). The planetary carrier 226 of this planetary gear unit abuts against a stopper portion 274 of the power transmitting member 270 on the vehicle outside. Accordingly, displacement of the planetary gear unit in the width direction of the vehicle is restricted by the thrust cylindrical roller bearing 840 and the stopper portion 274.

The rotational center of the ring gear 228 is the same as the axle center. The ring gear 228 is formed on the inner peripheral surface of an inner race side member 260 that is arranged so as to surround the sun gear 222 from the outer peripheral side. The outer peripheral surface of the inner race side member 260 forms an inner race of the axle bearing 100. In the illustrated example, the axle bearing 100 is a double-row angular ball bearing. The outer inner race with respect to the row on the vehicle outside is formed of a separate member than the inner race side member 260. This kind of separate member is integrated with the inner race side member 260 by fitting it around the outer periphery of the inner race side member 260 and crimping it thereto.

An outer race side member 262 is arranged so as to surround the inner race side member 260 from the outer peripheral side. The inner peripheral surface of the outer race side member 262 forms an outer race of the axle bearing 100. Seals 280 and 282 for preventing foreign matter from getting in and oil from flowing out are provided at the end portions in the width direction of the vehicle between the outer race side member 262 and the inner race side member 260.

The power transmitting member 270 is a disc-shaped member provided so as to cover the vehicle outside of the reduction mechanism. The circumferential groove 272 to which the vehicle outside end portion (peripheral wall portion) of the planetary carrier 226 is spline fitted is formed on the vehicle inside of the power transmitting member 270. The outer peripheral edge of the power transmitting member 270 is connected to the end portion on the vehicle outside of the outer race side member 262 by crimping or the like. That is, the power transmitting member 270 is fixed to the outer race side member 262 so that it blocks a generally circular opening on the vehicle outside of the outer race side member 262. The outer race side member 262 has a flange portion 263 that protrudes toward the outside in the radial direction on the outer peripheral surface. A bolt hole for fastening a hub bolt 264 is formed in this flange portion 263. The outer race side member 262 is fastened together with the brake disc 110 by the hub bolt 264 to the wheel 14 with the inner peripheral portion of the brake disc 110 being sandwiched between the flange portion 263 and the wheel 14.

In the foregoing structure, when the rotor 706 of the motor 700 rotates in response to a command from a vehicle control apparatus, not shown, the small diameter driving gear 212 of the counter gear mechanism 210 rotates, and as it does so, the large diameter counter gear 214 that is in mesh with the driving gear 212 rotates, thus realizing a first reduction. When the counter gear 214 rotates, the sun gear 222 which is integral with the counter gear 214 also rotates. As a result, the planetary gears 224 rotate while revolving around the sun gear 222. This rotation realizes a second reduction. The revolving motion of the planetary gears 224 is output by the planetary carrier 226 and transmitted to the power transmitting member 270 which is spline fitted to the planetary carrier 226. The tire/wheel assembly 10 is driven as the outer race side member 262, the brake disc 110, and the wheel 14 all rotate together with the power transmitting member 270.

The knuckle 400 mainly includes a main structure portion 410 positioned near substantially the center of the tire/wheel assembly 10, a cylindrical peripheral wall portion 430 which houses the main constituent elements of the motor 700 described above on the inner peripheral side, and a bottom portion 414 that faces the vehicle outside of the main constituent elements of the motor 700. In this example, the peripheral wall portion 430 and the bottom portion 414 of the knuckle 400 form the motor case 12. The main constituent elements of the motor 700 described above are arranged in a space to the inside in the radial direction of the peripheral wall portion 430 of the knuckle 400. The motor cover 750 is connected to the end portion on the vehicle inside of the peripheral wall portion 430 of the knuckle 400 so as to cover the space inside the peripheral wall portion 430. A gasket, not shown, for preventing oil from leaking out may also be provided at the portion where the peripheral wall portion 430 and the motor cover 750 connect.

Unlike the thin peripheral wall portion 430 and other ribs and the like, the main structure portion 410 of the knuckle 400 has sufficient strength and rigidity, and therefore serves to receive loads input via the portion where the axle bearing 100 is connected, the mounting points of the tie rod and the suspension arm (i.e., lower arm 520, etc.), and the brake caliper mounting point 122 (see FIG. 7).

The inner race side member 260 is connected by a bolt, not shown, to the end portion on the vehicle outside of the main structure portion 410 of the knuckle 400. An O-ring 610 for preventing oil from leaking out may be provided at the joining portion between the inner race side member 260 and the main structure portion 410 of the knuckle 400.

The main structure portion 410 of the knuckle 400 receives various loads input from the tire/wheel assembly 10 via the axle bearing 100 (i.e., the inner race side member 260) at the vehicle outside end portion. The counter gear mechanism 210 described above is arranged in the space inside the main structure portion 410 of the knuckle 400. The main structure portion 410 of the knuckle 400 receives various thrust loads and radial loads input via the bearing 830 and the bearing 800. The main structure portion 410 of the knuckle 400 is highly rigid so the dynamic load rating or the dynamic equivalent load of the bearings 830 and 800 is preferably set higher than it is for the corresponding bearings 820 and 810. As a result, a reasonable structure that can withstand a large load can be realized at portions with high strength and rigidity.

The main structure portion 410 of the knuckle 400 receives various loads input via the lower ball joint 500 and the like.

As shown in FIG. 6, the lower ball joint 500 is arranged farther toward the vehicle inside than the brake disc 110. The lower arm 520 is fastened to the lower ball joint 500 by a nut 522 from above. The lower arm 520 extends in the width direction of the vehicle and the vehicle inside end portion is supported by a vehicle body, not shown, via a bush and the like. The lower arm 520 may be any type. For example, it may be an L-shaped lower arm or a double ring type lower arm. The lower arm 520 works in cooperation with the upper arm or strut, not shown, to pivotally support the tire/wheel assembly 10 with respect to the vehicle body. Also, a spring and an absorber, not shown, are provided between the vehicle body and the lower arm 520. As a result, input from the tire/wheel assembly 10 to the vehicle body is reduced. The spring may be any type of spring coil or air spring. Also, the absorber may not only be a hydraulic absorber that applies damping action to vertical input, but also a rotary electromagnetic absorber that applies damping action to rotational input.

In this example embodiment, the motor 700 is offset upward with respect to the axle center, as described above. This increases the degree of freedom in the arrangement/position of the lower ball joint 500 (i.e. in the arrangement of the kingpin axis). For example, the lower ball joint 500 can also be moved as close to the brake disc 110 as possible, leaving only the necessary clearance, as shown in FIG. 6. As a result, the amount of offset of each member and the tire input point in the width direction of the vehicle is reduced, thereby enabling the necessary strength and rigidity of the members (such as the main structure portion 410 of the knuckle) to be reduced, which reduces weight.

The oil tank 310 is formed below the knuckle 400 and is arranged below, along a vertical line that is orthogonal to, the axle center in the tire/wheel assembly 10, as shown in FIG. 6. The oil tank 310 is preferably arranged below the lowest position of the gear portion of the reduction mechanism 200. Also, the oil tank 310 is arranged farther to the vehicle outside than the lower ball joint 500 and farther to the vehicle inside than the brake dust cover 112, as shown in FIG. 6.

The oil tank 310 is arranged using the space inside a hat portion 110a of the brake disc 110. In the example illustrated, the oil tank 310 is formed by a cover member 311 that is fixed to the knuckle 400 from the vehicle outside. The cover member 311 may be connected to the knuckle 400 by crimping or a bolt or the like. According to this structure, the oil tank 310 is arranged completely offset with respect to the lower ball joint 500 in the width direction of the vehicle. As a result, even if oil were to leak from the oil tank 310 due to the oil tank 310 being damaged or the like, the leaking oil would be reliably prevented from getting onto the lower ball joint 500, thus reliably preventing a decline in performance of the lower ball joint 500.

A lower end portion of the suction path 312 formed in the knuckle 400, as well as the oil return path 313 for returning oil formed in the knuckle 400, is communicated with the oil tank 310 (see FIG. 6). The oil tank 310 serves to collect oil for cooling the motor 700 or lubricating the reduction mechanism 200.

Also, a drain flow path 314 and a filler flow path 316 formed in the knuckle 400 are also communicated with the oil tank 310 (see FIG. 7). The openings of the drain flow path 314 and the filler flow path 316 are closed by a drain plug (see FIG. 7) and a filler plug (not shown), respectively.

The oil pump 300 is arranged between the motor 700 and the planetary gear set 220 of the reduction mechanism 200 in the width direction of the vehicle. More specifically, the oil pump 300 is provided on the vehicle inside end portion of the shaft 250. In the example shown in FIG. 6, the oil pump 300 is arranged inside the counter gear 214 of the counter gear mechanism 210, i.e., to the inside of the counter gear 214 in the radial direction. More specifically, the convex portion 412 of the knuckle 400 is accommodated within a cavity 252 to the inside in the radial direction of a vehicle inside end portion (i.e., of a portion with a larger diameter for forming the counter gear 214) of the shaft 250. A concave portion 413 is formed to the inside of the convex portion 412 in the radial direction. The oil pump 300 is provided in this concave portion 413. The inside portion of this concave portion 413, as well as the area around a pump rotating shaft 302 that extends into the concave portion 413, is sealed by a seal member 305.

The oil pump 300 may not only be a trochoid pump as shown in the drawings, but any one of a variety of gear pumps such as an external gear pump or an internal gear pump (with or without a crescent-shaped partition), or another type of hydraulic pump such as a vane pump, for example.

The oil pump 300 operates by rotational output of the motor 700. More specifically, the inner rotor of the oil pump 300 is connected to the pump rotating shaft 302 which is integral with the shaft 250, and thus rotates when the shaft 250 rotates. That is, the inner rotor of the oil pump 300 is driven by the same shaft that the counter gear 214 is provided on. When the inner rotor rotates, so too does the outer rotor which has a rotational axis that is offset with respect to the rotational axis of the inner rotor. As a result, oil in the oil tank (reservoir tank) 310 is drawn up via the suction path 312. The oil that is drawn in through the inlet 304 (see FIG. 7) is then caught between the inner and outer rotors of the oil pump 300 and discharged from an outlet 306 (see FIG. 7) mainly to the oil passages 910 and 920.

Next, the main oil passages 910, 920, and 432 through which the oil that is discharged from the oil pump 300 flows, as well as the member that forms these oil passages (mainly an oil delivery 930), the heat pipes 1 provided inside the oil passages 432, and the radiation fins 2 will be described.

As shown in FIG. 6, the oil passage 910 is formed in the shaft 250 in the lengthwise direction of the shaft 250. The vehicle inside end portion of the oil passage 910 is communicated with the outlet 306 of the oil pump 300 (see FIG. 7). The vehicle outside end portion of the oil passage 910 has an opening 914 that opens to the vehicle outside from the tip end portion of the shaft 250. Oil holes 912 formed in the radial direction of the shaft 250 are communicated with the oil passage 910.

FIG. 7 shows the oil passages for cooling a motor 700 and lubricating the bearings 820, 830, and 800, and the heat pipes 1 provided in the cooling oil passages, and is a plan view, as viewed from the vehicle inside, of the inside of the peripheral wall portion 430 of the knuckle with the motor cover 750 and the internal elements of the motor 700 and the like omitted. In the drawing, members of little relevance in describing the oil passages and the heat pipe 1 are omitted as appropriate.

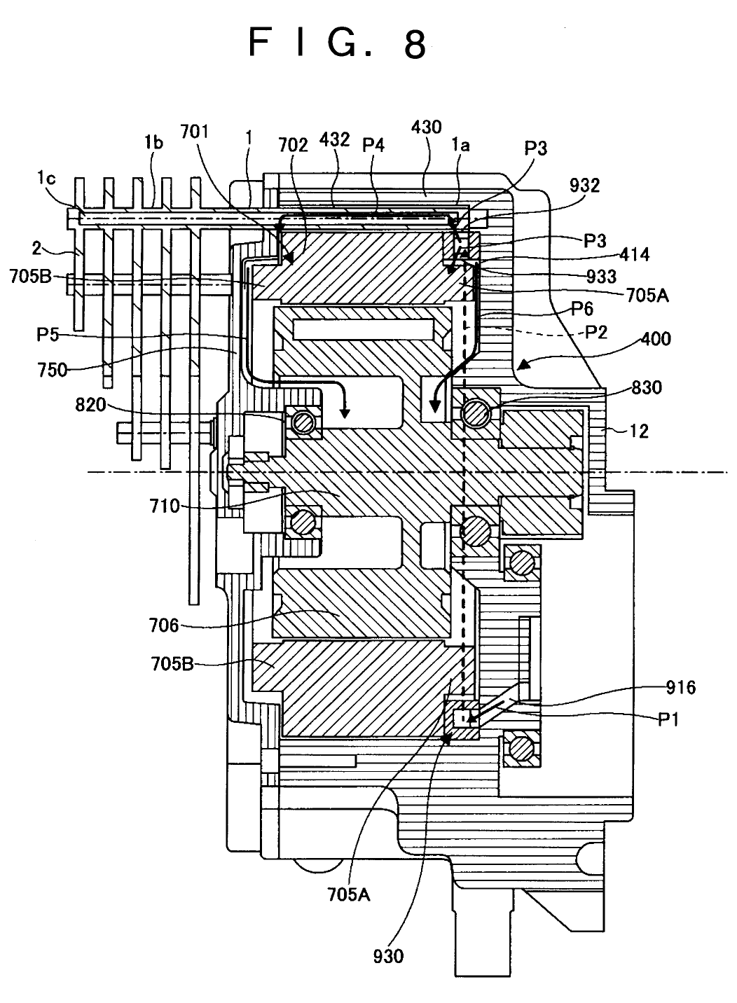

FIG. 8 is a sectional view cut along a different plane than is shown in the sectional view in FIG. 6, and illustrates the relationship between the heat pipes 1 and the flow of oil from the oil pump 300 to the oil delivery 930 and the flow of oil near the upper portion of the motor 700. In FIG. 8, a pressure oil passage 916 leading from the oil pump 300 is shown so that it appears to extend parallel to the axle center for convenience of explanation. In actuality, however, the pressure oil passage 916 does not extend parallel to the axle center, but instead extends in a direction that connects the outlet 306 of the oil pump 300 with an inlet hole 936 of the oil delivery 930, as shown in FIG. 7. However, depending on the manner in which the motor 700 is offset and the like, it is also possible to have the pressure oil passage 916 extend parallel to the axle center.

The oil passage 920 (see also FIG. 6) provided using the space near the coil end 705A is communicated with the outlet 306 of the oil pump 300. The oil passage 920 encircles the coil end 705A at a corner portion near the base of the peripheral wall portion 430 of the knuckle 400, as shown in FIG. 7. The oil passage 920 is formed by a member 930 (i.e., the oil delivery 930) that is separate from the knuckle 400.

The oil delivery 930 is arc-shaped with an inner radius that is slightly larger than the radius of the outer periphery of the coil end 705A, as shown in FIGS. 6 and 7. The oil delivery 930 is tubular such that the oil flows inside it, as shown in FIGS. 6 and 8. The oil delivery 930 is made of aluminum casting or resin molding, for example.

The oil delivery 930 is arranged in the gap or space on the outer peripheral side of the coil end 705A on the vehicle outside of the stator coil 704, as shown in FIGS. 6 and 8. That is, the oil delivery 930 is arranged so as to surround the outer peripheral side of the coil end 705A of the stator core 702. In this case, there is no longer a need to provide a separate space for arranging the oil delivery 930 so an efficient arrangement that does not increase the size of the motor 700 can be realized.

The oil delivery 930 is arranged so as to be tightly sandwiched in the vehicle width direction between a bottom surface 414 of the knuckle 400 and the vehicle outside end surface of the stator core 702, as shown in FIGS. 6 and 8. Meanwhile, in the radial and axial (i.e., vehicle width) directions, the oil delivery 930 is arranged so that a gap is formed between it and the outer peripheral side of the coil end 705A, as shown in FIGS. 6 and 8.

The oil delivery 930 has the inlet hole 936 formed in an angular position near the axle center, as shown in FIG. 7. This inlet hole 936 opens in the axial direction to the vehicle outside. The pressure oil passage 916, which provides communication between the inlet hole 936 of the oil delivery 930 and the outlet 306 of the oil pump 300, is formed in the knuckle 400, as shown in FIGS. 7 and 8.

Also, the oil delivery 930 has distribution holes 932 that open to the outside in the radial direction formed in angular positions at appropriate intervals in the circumferential direction, as shown in FIG. 7. The oil passages 432 that extend in the axial direction are formed at each of the angular positions corresponding to the distribution holes 932 in the inner peripheral surface of the peripheral wall portion 430 of the knuckle 400, as shown in FIG. 7.

Also, the oil delivery 930 has distribution holes 933 that open to the inside in the radial direction formed in angular positions at appropriate intervals in the circumferential direction, as shown in FIG. 7. In the example shown in the drawing, the distribution holes 933 are formed in the same angular positions as the distribution holes 932. Alternatively, however, the set number and angular positions of the distribution holes 933 may be different than those of the distribution holes 932.

As shown in FIGS. 6, 7, and 8, the heat absorbing portions 1a of the heat pipes 1 are arranged inside the oil passages 432. The heat absorbing portions 1a of the heat pipes 1 may be arranged contacting the outer periphery of the stator 701 or may be arranged in positions near the stator 701 considering machining tolerances and other difficulties. The heat absorbing portions 1a of the heat pipes 1 absorb the heat that was generated in the stator 701 directly from the stator 701 itself.

As shown in FIGS. 6 and 8, heat radiation portion 1b that extend in the axial direction like the stator 701 and protrude out of not only the oil passages 432 but also the case cover 750 are provided on the outer portion. The radiation fins 2 are integrally formed on these heat radiation portions 1b.

As shown in FIGS. 6 and 8, the heat pipes 1 may be tubular, the inside of which is a vacuum and filled with a small amount of operating liquid 1c such as water or a chlorofluorocarbon substitute, which is sealed inside. The inside wall of the heat pipe 1 may be formed of a capillary tube structure. Also, the material of which the heat pipe 1 is made may be a metal with excellent thermal conductivity such as copper or aluminum.

The heat absorbing portions 1a of the heat pipes 1 may be provided contacting the stator 701, which is preferable, as described above. However, when they are provided near the stator 701 due to difficulties in machining tolerances and other difficulties, the heat of the stator 701 is absorbed via the oil that is filled in the gap between the stator 701 and the heat pipes 1. In this case as well, the heat absorbing portions 1a are positioned close to the stator 701 so the heat generated by the stator 701 can be efficiently absorbed. Therefore, even if the oil passages 432 are sufficiently large, the heat absorbing portions 1a may simply be arranged as close as possible to the stator 701. Also, in this example embodiment, the heat pipes 1 are arranged along the axis of the stator 701. However, the heat pipes 1 may be formed in arcs in the radial direction.

The heat radiation portion 1b of the heat pipes 1 are formed on the outer portion of the motor cover 750 on the vehicle inside, as shown in FIGS. 6 and 8. The heat radiation portion 1b radiate the heat absorbed by the heat absorbing portions 1a so they need to be provided in a space where heat can be dissipated. Accordingly, they can be arranged at least outside the oil passages 432 or on the outer portion of the motor case 12 that houses the motor 700. Incidentally, because the heat radiation portions 1b are provided on the outer portion of the case of the in-wheel motor, there is a danger of them being damaged by flying rocks or the like. Providing the motor 700 at the upper portion of the tire/wheel assembly reduces the danger of the heat radiation portions 1b becoming damaged.

The radiation fins 2 are provided integrally with the heat radiation portion 1b on the outer portion of the motor cover 750, as shown in FIGS. 6, 7, and 8, and thus efficiently radiate heat that was emitted from the heat radiation portions 1b. In order to improve the radiation efficiency of the heat radiation portions 2, a plurality of the fins may be arranged at predetermined intervals toward the vehicle inside, as shown in FIGS. 6 and 8. Also, the radiation fins 2 may be shaped like long thin plates, as shown in FIG. 7, or, in order to further improve their radiation efficiency, they may be shaped like flat plates with large surface areas. The radiation fins 2 extend vertically so that they do not apply excessive force to the heat radiation portion 1b of the heat pipes 1, but they may also be provided angled toward the center (i.e., extending radially outward). Incidentally, the radiation fins 2 may be made of metal or the like which has excellent thermal conductivity such as copper or aluminum.

A plurality of the heat pipes 1 may be provided at appropriate intervals along the outer circumference of the stator 701. Also, the performance of the heat pipes 1 as well as the shapes of the heat fins 2 may be different in each location according to the heat generating characteristics of the stator 701.

Next, the operation of the heat pipes 1 and the flow of oil when the oil pump 300 is operating in the oil passages 910, 920, and 432 described above will be described.

The oil that was discharged from the outlet 306 (see FIG. 6) of the oil pump 300 to the oil passage 910 is supplied to the bearing 810 (see FIG. 6) via the opening 914 in the tip end portion of the shaft 250, and supplied to the planetary gears 224 (see FIG. 6) via the oil holes 912 by centrifugal force generated as the shaft 250 rotates. The oil supplied in this way is used to lubricate the bearing 810, as well as the roller bearings 225 at the rotational center of the planetary gears 224. The oil used for cooling or lubrication in this way is then finally returned to the oil tank 310 via the oil return path 313 by gravity.

Also, oil is supplied from the outlet 306 (see FIG. 7) of the oil pump 300 to the oil passage 920 (i.e., the flow path inside the oil delivery 930), as shown by arrow P1 in FIGS. 7 and 8, via the pressure oil passage 916 and the inlet hole 936 of the oil delivery 930. The oil supplied to the oil passage 920 is then delivered to the area around the coil end 705A, as shown by arrow P2 in FIGS. 7 and 8. This oil is then delivered radially inward and outward out of the oil delivery 930 via the plurality of distribution holes 932 and 933, as shown by arrow P3 in FIGS. 7 and 8.

The oil discharged into the oil passages 432 via the distribution holes 932 is led in the direction in which the oil passages 432 extend, as shown by arrow P4 in FIG. 8, so that it flows around the entire outer peripheral surface of the stator core 702. Here, the heat absorbing portions 1a of the heat pipes 1 absorb the heat generated by the stator core 702 either directly or via the oil that is supplied in the oil passages 432.

When the heat absorbing portions 1a of the heat pipes 1 absorb heat from the stator core 702, the operating liquid 1c inside the heat pipes 1 evaporates, absorbing the latent heat. The resultant evaporation gas moves to the heat radiation portions 1b, which are at a low temperature, at an extremely fast rate of speed comparable to the speed of sound. The evaporation gas that has moved to the heat radiation portion 1b then condenses at the heat radiation portions 1b, returning to liquid form by which it releases the latent heat. The heat released from the pipe wall of the heat radiation portion 1b is efficiently radiated through the radiation fins 2 that are integrally formed with the heat radiation portions 1b. Meanwhile, once back to its liquid form, the operating liquid 1c returns to the heat absorbing portions 1a by the capillary tube phenomenon. This changing of phases occurs continuously such that the heat from the stator core 702 is efficiently released to the outer portion of the motor 700, thus efficiently cooling the stator core 702.

Also, the oil supplied inside the motor 700 via the distribution holes 932 and the oil passages 432 travels in the direction of arrow P4 in FIG. 8 toward the vehicle inside while serving as a medium to dissipate the heat of the stator core 702 by fast heat exchange by the heat pipe 1, as described above. As shown by the end of arrow P4, the oil contacts the coil end 705B on the vehicle inside through the gap between the motor cover 750 and the stator core 702, thereby cooling the coil end 705B. Also, as shown by arrow P5 in FIG. 8, the oil supplied via the distribution holes 932 and the oil passages 432 reaches the output shaft 710 of the motor 700, where it lubricates the bearing 820. Similarly, the oil supplied inside the motor 700 through the distribution holes 933 reaches the output shaft 710 of the motor 700 through the gap between the bottom portion 414 of the knuckle 400 and the stator coil 704, where it lubricates the bearing 830, as shown by arrow P6 in FIG. 8.

Meanwhile, the oil discharged through the distribution holes 933 directly contacts the coil end 705A of the stator core 702, as shown by arrows P3 of FIGS. 7 and 8 (i.e., the arrows pointing to the inside in the radial direction), and cools the entire stator coil 704 around the coil end 705A. This cooling is not beyond the radiation effect of the heat pipe 1 and is therefore achieved by the heat of the oil being released into the ambient air via the knuckle 400 and the like.

In this way, oil flows through the inside of the motor 700 in order to function as a heat exchange medium. However, arranging the heat pipe 1 in a location extremely close to the heat source in the oil passage improves the cooling efficiency of the motor 700 provided in the in-wheel motor.

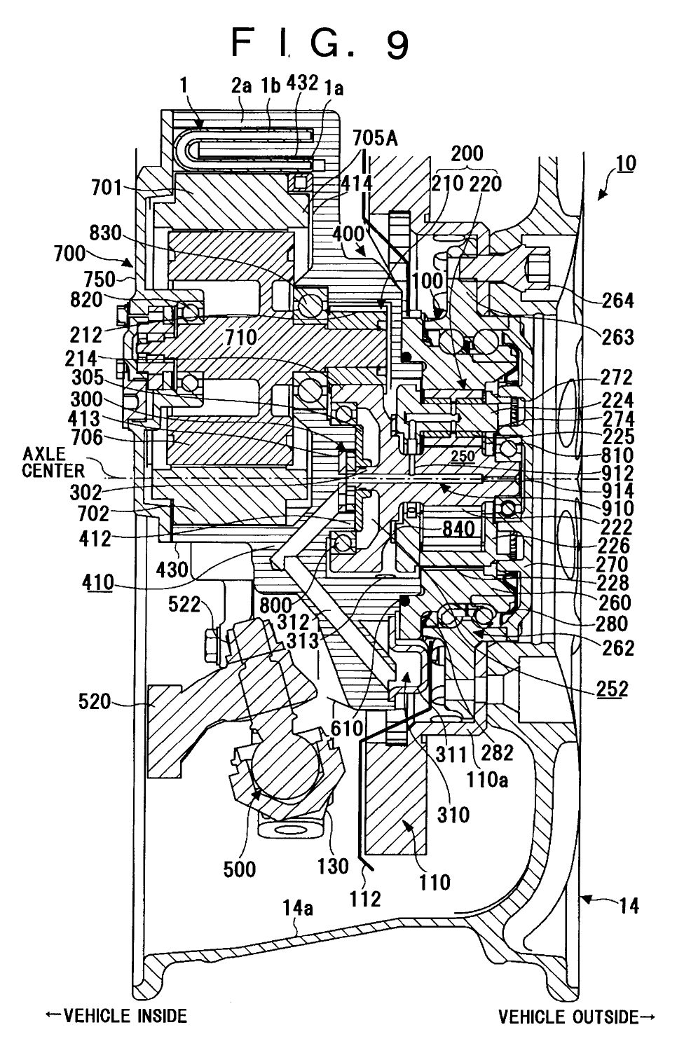

FIG. 9 is an example in which a motor of a different structure than the motor shown in FIGS. 6, 7, and 8 is applied to an in-wheel motor.

The structure shown in FIG. 9 is the same as that shown in FIG. 6 except that the shapes of the heat pipes 1 and the radiation fins 2 are different, so a description of the structure will be omitted. Also, the shape of the heat pipes is the same as that described in FIG. 4 so a detailed description thereof will be omitted. The heat pipes 1 bend back in the middle and are provided with heat radiation portions 1b on the vehicle outside. As a result, the heat pipes 1 provided in the motor 700 are completely housed inside the motor cover 750 toward the vehicle inside. This kind of structure greatly reduces the possibility of damage to the heat pipes 1 by flying rocks and the like, while also enabling the heat pipes 1 to have a compact shape that enables them to be housed within the motor cover 750.

While example embodiments of the invention have been illustrated above, it is to understood that the invention is not limited to details of the illustrated embodiments, but may be embodied with various changes, modifications or improvements without departing from the spirit and scope of the invention.

What is claimed is:

1. A motor comprising:
a stator;
an oil passage that supplies oil to the stator; and
a heat pipe,
wherein the heat pipe has a heat absorbing portion provided in a position inside the oil passage and near the stator.

2. A motor comprising:
a stator;
an oil passage that supplies oil to the stator; and
a heat pipe,
wherein the heat pipe has a heat absorbing portion provided in a position inside the oil passage and contacting the stator.

3. The motor according to claim 1, wherein the heat pipe has a heat radiation portion provided outside of the oil passage.

4. The motor according to claim 2, wherein the heat pipe has a heat radiation portion provided outside of the oil passage.

5. The motor according to claim 3, wherein the motor is housed in a motor case, and the oil passage is arranged between an outer periphery of the motor and the motor case.

6. The motor according to claim 4, wherein the motor is housed in a motor case, and the oil passage is arranged between an outer periphery of the motor and the motor case.

7. The motor according to claim 5, further comprising:
a radiation fin,
wherein the heat radiation portion of the heat pipe is provided on an outer portion of the motor case and is formed integral with the radiation fin.

8. The motor according to claim 6, further comprising:
a radiation fin,
wherein the heat radiation portion of the heat pipe is provided on an outer portion of the motor case and is formed integral with the radiation fin.

9. The motor according to claim 7, wherein the radiation fin is provided in plurality, stacked in the direction in which the heat pipe extends.

10. The motor according to claim 8, wherein the radiation fin is provided in plurality, stacked in the direction in which the heat pipe extends.

11. The motor according to claim 5, further comprising:
a radiation rib provided on an outer periphery of the motor case,
wherein the heat radiation portion of the heat pipe is provided inside the radiation rib.

12. The motor according to claim 6, further comprising:
a radiation rib provided on an outer periphery of the motor case,
wherein the heat radiation portion of the heat pipe is provided inside the radiation rib.

13. The motor according to claim 11, wherein the radiation rib is provided protruding on an outer peripheral portion of the motor case corresponding to the oil passage and is formed integral and continuous with the motor case.

14. The motor according to claim 12, wherein the radiation rib is provided protruding on an outer peripheral portion of the motor case corresponding to the oil passage and is formed integral and continuous with the motor case.

15. The motor according to claim 11, wherein the heat absorbing portion of the heat pipe is fit into the oil passage with a gap between the heat absorbing portion and the oil passage, and the heat radiation portion of the heat pipe is fit, in a sealed manner, into a hole in the radiation rib.

16. The motor according to claim 12, wherein the heat absorbing portion of the heat pipe is fit into the oil passage with a gap between the heat absorbing portion and the oil passage, and the heat radiation portion of the heat pipe is fit, in a sealed manner, into a hole in the radiation rib.

17. A wheel assembly comprising:
the motor according to claim 1 for driving a wheel, which is arranged within the wheel;
a reduction mechanism which includes a counter gear mechanism and a planetary gear set;
an oil pump that is driven by rotational output of the counter gear mechanism; and
an oil delivery which is arranged around an outer peripheral side of a coil end of the motor, and has an inlet hole through which oil from an the oil pump flows and a distribution hole that is communicated with the oil passage.

18. A wheel assembly comprising:
the motor according to claim 2 for driving a wheel, which is arranged within the wheel;
a reduction mechanism which includes a counter gear mechanism and a planetary gear set;
an oil pump that is driven by rotational output of the counter gear mechanism; and
an oil delivery which is arranged around an outer peripheral side of a coil end of the motor, and has an inlet hole through which oil from an the oil pump flows and a distribution hole that is communicated with the oil passage.
